(19) United States
(12) Patent Application Publication
(10) Pub. No.: US 2015/0209954 A1
(43) Pub. Date: Jul. 30, 2015

(54) AUGER RACK WITH VERTICAL SECUREMENT MEANS FOR SUSPENDED STORAGE, USE AND/OR TRANSPORT OF AUGERS OR DRILL BITS

(71) Applicant: Craig Richard Hokanson, Clearfield, UT (US)

(72) Inventor: Craig Richard Hokanson, Clearfield, UT (US)

(21) Appl. No.: 14/164,058

(22) Filed: Jan. 24, 2014

(51) Int. Cl. B25H 3/00; B62D 33/00; E21B 7/02; E21B 7/00; B25H 3/04; A47B 81/00

(52) U.S. Cl. CPC B25H 3/003; B25H 3/04; A47B 81/00; E21B 7/027; E21B 7/005; B62D 33/00

(57) ABSTRACT

A rack is disclosed, adapted to facilitate efficient transport and interchange of augers and/or mining drill bits used in construction by either single operator or a plurality of operators. The rack comprises a plurality of elongated members affixed to one another; and, in some embodiments, a plurality of L-shaped, cantilevered brackets from which augers or drill bits are suspended during transport, storage, interchange, and the like.

### CROSS-REFERENCE TO OTHER APPLICATIONS

This patent application claims priority to, and incorporates, U.S. provisional patent application Ser. No. 14/795,476 entitled “Auger Rack with Vertical Securement Means for Suspended Storage, Use and/or Transport of Augers or Drill Bits” filed on Jan. 25, 2013 for Craig Richard Hokanson.

### BACKGROUND OF THE INVENTION

1. Field of the Invention

This invention relates to construction or farm implements, and more particularly relates to an implement for storage or transportation and interchange of augers used in drilling earth in connection with construction.

2. Description of the Related Art

Augers and drilling apparati are well-known in the art. Earth augers comprise sharp helical tools, varying in width from only a few centimeters to several meters, used in drilling to extract earth and aggregate from a ground surface in a construction area. Augers are also used to facilitate the construction of wells, footings, mines, underground piping, holes for pipes or poles, and the like. Augers are used in a various apparati to move fluids, gravel, grain, snow, oil, and the like, from one position to another. Augers are used within larger machines to move each of these items into or through a machine.

In construction, augers, which are used to drill holes in earth, can range from just a few pounds to several tons in weight. These augers are detachably connected to mechanized vehicles, drilling stations, and/or auger driver units at their proximal ends. The forward end, or distal end, of the auger is used for engaging rock and other materials including aggregates. The augers themselves are cumbersome to transport from one location to another as well as to store. Because of their size, it is difficult to safely transport a plurality of augers simultaneously, and there exists no efficient means in the art of storing or securing augers during transport, much less means of doing so by a single human operator. Additionally, auger drive units are necessary for operation of heavy augers. These auger drive units comprise electro-mechanical, hydraulic motors, usually affixable to a skid steer, backhoe, excavator, mini excavator, compact track loader, Bobcat®, truck-mounted Derrick digger, pressure digger, or any of a plethora of various types of tractors and track vehicles.

Typically, large pressure drill augers are transported to a construction site on a flat bed truck or trailer then fastened or lashed by their coupler to a crane jib and hoisted in the air. The augers hang near vertically once hoisted. Usually, an operator will climb the auger by its flighting, grab the coupler of the auger bit with one hand and a drive unit with the other, and align and couple them together manually. This approach is prone with difficulty and danger to the operator. There is a need in the art for safer and more efficient apparati and methods. The needs are the same for operators making use of drill bits used in mining and oil and natural gas applications.

Using current methods, systems, and apparati, at a minimum, two to three operators/individuals are needed to transport, secure, couple and ready a track vehicle, auger drive unit, and an auger for drilling. It can be very dangerous for a single operator, or even two operators, to attempt to ready the auger, vehicle, and auger drive unit alone.

It is therefore desirable that an auger rack be provided which facilitates ease of vertical auger transport, storage, use and interchange.

### SUMMARY OF THE INVENTION

From the foregoing discussion, it should be apparent that a need exists for an auger rack for vertical auger transport, storage, use and interchange. Beneficially, such an apparatus would overcome many of the difficulties with prior art by providing a safer means for securing, transporting, storing, using and interchanging a plurality of augers by a single operator.

The present invention has been developed in response to the present state of the art, and in particular, in response to the problems and needs in the art that have not yet been fully solved by currently available aparati. Accordingly, the present invention has been developed to provide an auger rack for suspending augers, the auger rack comprising: a generally rectangular frame comprising: two or more bearing beams between 0.1 meters and 20 meters in length, the bearing beams comprising elongated structural components formed from a rigid metallic substance, each bearing beam affixed to one or more upwardly rising end columns; two or more upwardly rising end columns, between 0.2 meters and 7 meters in length, the end columns comprising elongated structural components formed from a rigid metallic substance, each end column affixed to a bearing beam and to a top beam; or more top beams between 0.2 meters and 10 meters in length, the top beams comprising elongated structural components formed from a rigid metallic substance, each top beam affixed to one or more end columns; a plurality of L-shaped cantilevers affixed in parallel to a top beam for suspending auger bits, wherein auger bits are suspended between the L-shaped cantilevers at a dish axially circumventing a shaft of the auger bit.

The auger rack may further comprise a plurality of outriggers extending laterally from the base of the end columns across a ground surface. The L-shaped cantilevers may be even spaced apart across the top beam.

The auger rack may further comprise a plurality of baseplates for engaging a ground surface. The auger rack, in some embodiments, further comprises one or more diagonal braces affixed to a bearing member at one end and an end column at an opposing end. The auger rack may also comprise one or more stiffeners affixed to two bearing member at opposing ends.

A method of transporting, connecting, and disconnecting an auger to an auger drive unit is also disclosed, the steps of the method comprising: suspending an auger bit vertically from its dish with its coupler disposed on the auger's upward end, the auger bit suspended between two cantilevers, the cantilevers affixed to a top beam, wherein a diameters of the dish exceeds a width between the cantilevers; transporting the suspended auger to a construction situs; lowering an auger drive until into position above the suspended auger; connecting the auger drive until to the coupler of the auger; lifting the auger out, and away from, the cantilevers; using the auger in construction; suspending the auger bit vertically from its dish with by its coupler between two cantilevers; and transporting the suspended auger to another situs.

The method may further comprise storing the suspended auger between cantilevers. The method may further comprise locking the suspended auger in place between cantilevers using a locking mechanism. The method may further comprise cementing end columns affixed to the top beam in place on a ground surface.

The method may further comprise transporting augers in a ready to use position in a rack integrated into the design of one of a trailer and truck bed, the augers suspending from one of brackets and L-shaped cantilevers. In some embodiments, the method comprises securing the augers on the rack to prevent swaying.

Another auger rack for suspending augers is also disclosed, the auger rack comprising: a generally rectangular frame comprising: one or more bearing beams between 0.1 meters and 20 meters in length, the beaming beams comprising elongated components formed from a rigid metallic substance, each bearing beam affixed to one or more upwardly rising end columns; two or more upwardly rising end columns, between 0.2 meters and 7 meters in length, the end columns comprising elongated components formed from a rigid metallic substance, each end column affixed to a bearing beam and to a top beam; or more top beams between 0.2 meters and 10 meters in length, the top beams comprising elongated structural components formed from a rigid metallic substance, each top beam affixed to one or more end columns; a plurality of brackets affixed in parallel to a top beam for suspending auger bits, wherein auger bits are suspended between the brackets.

One or more of the end columns and the bearing beams may comprise I-beams. The brackets may be evenly spaced apart from one another. The auger rack may be affixed to one of a truck bed and trailer.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an upper elevational perspective view of an auger rack in accordance with the present invention;

FIG. 2 is a lower elevational perspective view of an auger rack in accordance with the present invention;

FIG. 3 is a forward perspective view of an auger rack in accordance with the present invention;

FIG. 4 is a side perspective view of an auger rack in accordance with the present invention;

FIG. 5 is a side elevational perspective view of an auger rack in accordance with the present invention;

FIG. 6 is a side elevational perspective view of an auger rack cemented in the ground in accordance with the present invention;

FIG. 7 is a side perspective view of an auger rack in a truck bed in accordance with the present invention;

FIG. 8 is a flow chart of the steps of a method for transporting and/or interchanging augers in accordance with the present invention;

FIG. 9 is a side perspective view of an auger rack in accordance with the present invention; and

FIG. 10 is a side perspective view of an auger rack, showing an exploded view of a locking mechanism, in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

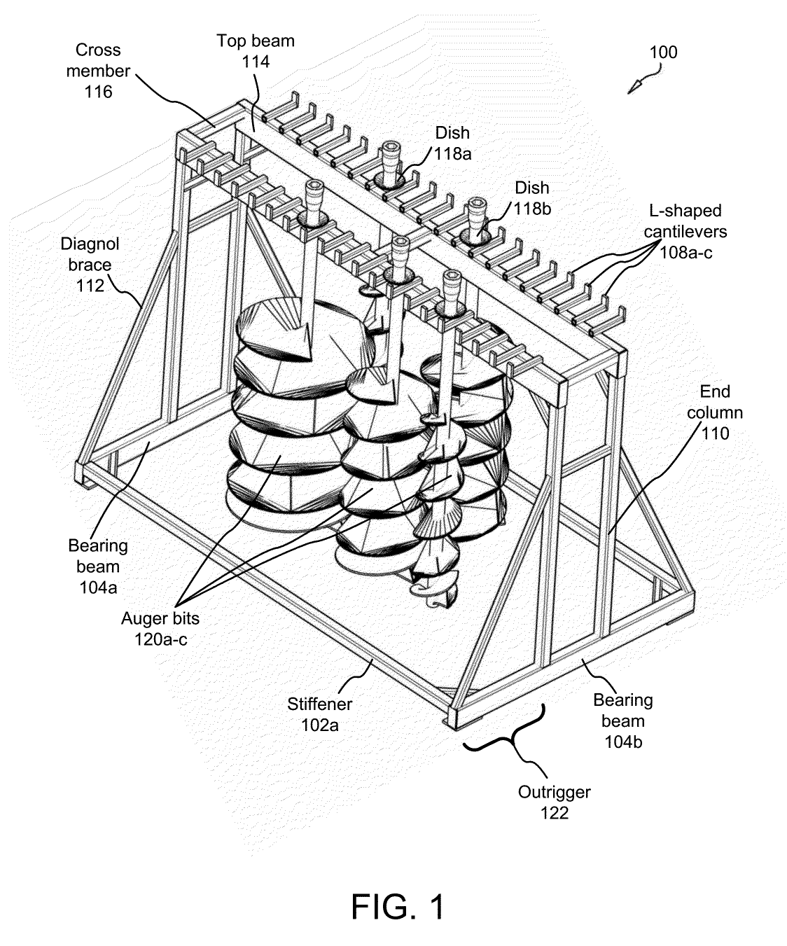

FIG. 1 is an upper elevational perspective view of an auger rack 100 in accordance with the present invention. The auger rack 100 comprises a stiffener 102a, a bearing beam 104a, a bearing beam 104b, L-shaped cantilevers 108a-c, an end column 110, a diagonal brace 112, a top beam 114, a cross member 116, an outrigger 122, and augers 120a-c each comprising a dish 118.

The components 102-118, less the L-shaped cantilevers 108a-c, form the frame. These members 102-118 are bolted, adhered, nailed, snapped, riveted, affixed, or welded to one another to form the frame. In some embodiments, the frame is manufactured partially or wholly as one integrated piece.

Each of the members 102-118, in the shown embodiment, comprise elongated, hollow steel tubes (except the L-shaped cantilevers 108 which are solid). Each of the members 102-118 may alternatively comprise rods, beams, I-beams, angle beam, bar stock, H-beams, C-beams (i.e. channel), plates, pipes, or other structural members. The members 102-118 may define a number of holes, bores, or apertures drilled through the members 102-118 for securing aftermarket components to the frame or one another. These apertures may be circular in shape and serve the purpose of receiving the L-shaped cantilevers 108 (e.g. brackets) or receptacles described below. The L-shaped cantilevers 108 may be solid or hollow.

The members 102-118 may be manufactured from polymers, wood, metals, alloys, and the like. The member 102-118 may be curved, bent, or angled along either their y-axis, z-axis, or an orthogonal x-axis.

The members 102-118 collectively form the frame, or chassis of the auger rack 100. In the shown embodiment, the frame is rectangular (“rectangular” defined herein to include the square shape) from a top perspective view looking down the z-axis. In alternative embodiments, the frame, from this perspective, may be circular, elliptical, irregular, triangular, polygonal, or otherwise shaped.

The stiffener 102a further stabilizes and strengthen the auger rack 100 by the interconnecting the outriggers 122. In the shown embodiment, the stiffener 102 is affixed to both the bearing beam 104a and the bearing beam 104b. In alternative embodiments, the stiffener 102 may be affixed to the end column 110.

The L-shaped cantilevers 108 may comprise anchor bolts. They may be J-shaped. In some embodiments, the L-shaped cantilevers are replaced with upwardly rising (or inclined) cantilevers.

In some embodiments, the L-shaped cantilevers 108 are also adjustable along the top beam 114 such that the space between L-shaped cantilevers 108 can be adjusted to accommodate auger bits 120 of different sizes. The L-shaped cantilevers 108 may slide along a track affixed to, or recessed into, the top beam 114.

The L-shaped cantilevers 108 may be affixed to the top, bottom, side or otherwise using means known to those of skill in the art, including bolting, welding, brackets, and the like.

In various embodiments, the rack 100 is configured to allow a drive motor to hang from brackets or cantilevers 108 along side the auger(s) 120.

In some circumstances it may be necessary for safety reasons to suspend the auger from the drive motor with the drive motor siting cradled in the L shaped cantilever 108 this may require additional cantilevers at different elevations and lengths to aid in support using a retention rod, fastener, clamp, strap, rope, chain, cable, wire, mechanism pins bolts, buckles, sleeves, sleeve pins, claps or other locking mechanisms to secure it for safety reasons, and the like.

The auger bits 120 may detachably affix to a vehicle having an auger drive unit. The auger drive unit, vehicle and auger all known in the prior art. The auger drive unit may comprise either a hex drive, square drive or round drive as known to those of skill in the art.

The augers 120 are suspended from the auger rack 120 between L-shaped cantilevers 108. The width between L-shaped cantilevers, in the shown embodiments, is less than the diameter of a dish, or collar, circumscribing axially the shaft of each auger 120. The augers 120 are suspended with their couplers up, such that the augers 120 can be connected to an auger drive unit positioned above the augers 120, which auger drive until then removes the augers 120 from the auger rack 100.

The term “auger” as used herein is defined to include earth augers and drill bits used in mining applications. Thus, the term “auger rack” defines a rack for suspending augers and/or mining drill bits, including drill bits used in oil and natural gas applications.

In some embodiments, the auger rack 100 further comprises bolts, buckles, sleeves, sleeve pins, claps or other locking mechanisms for locking the auger rack 100 to the bed of a truck, ground surface, or the like.

In some embodiments, the outrigger 122 is telescopic, extrudable, adjustable, extendable, or retractable using means known to those of skill in the art.

In some embodiments, the outrigger 122 portions of the bearing beams 104 are hingedly connected to the auger rack 100 such that the outriggers 122 may be lifted vertically into vertical parallel with the end columns 110.

In various embodiments of the present invention, the end columns 110 are telescopic or otherwise adjustable in height to accommodate augers of various heights. End columns and bearing beams may be disassembled, in some embodiments, from the rack 100 to reduce shipping space for distribution from the factory.

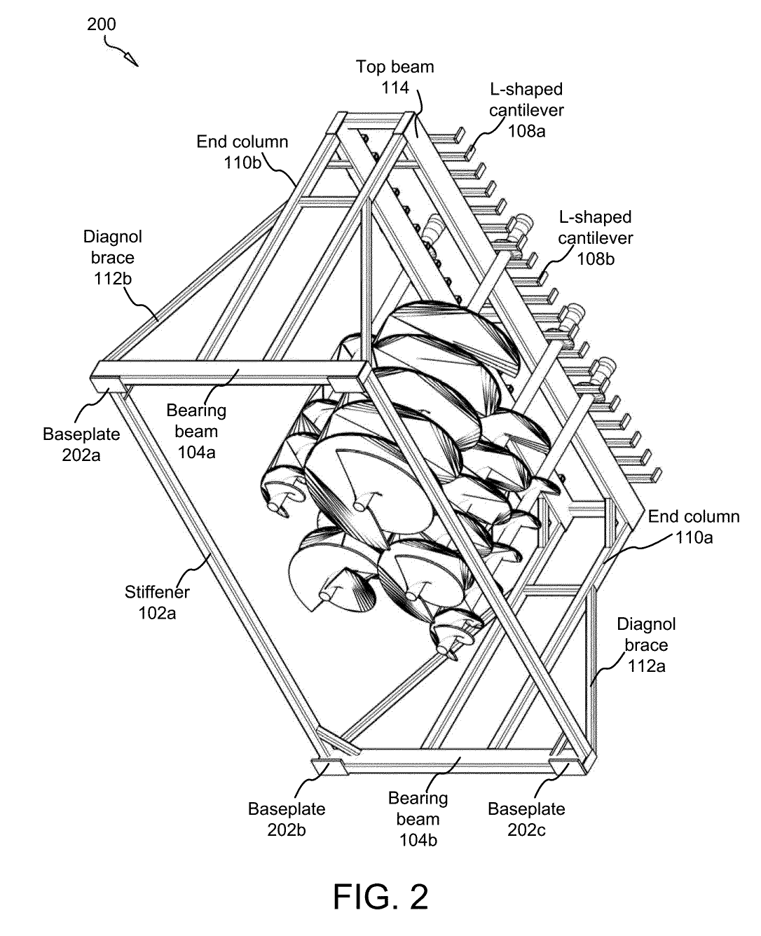

FIG. 2 is a lower elevational perspective view of an auger rack 200 in accordance with the present invention. The auger rack 200 comprises a stiffener 102a, a bearing beam 104, a bearing beam 104b, L-shaped cantilevers 108a-c, an end column 110, a diagonal brace 112a, a diagonal brace 112b, a top beam 114, L-shaped cantilevers 108a-b, and baseplates 202a-c.

The auger rack 200 includes baseplates 202a-c for engaging a ground surface. The baseplates 202a-c may be affixed underneath the outrigging 122, the columns 110, or any other component of the frame. In some embodiments, the baseplates 202a-c are affixed to casters, locking or nonlocking.

Various embodiments of the present invention include a ladder affixed to one or more of the end columns 110. The ladder may abut, provide access to, or incorporate a catwalk behind or between the top beam(s) 114 as further described below.

In some embodiments of the present invention, the augers 120 are locked or affixed to the auger rack 100 using a retention rod, bar, lever lock, binder, fastener, clamp, strap, rope, chain, cable, wire, mechanism pins, bolts, buckles, sleeves, sleeve pins, claps, other locking mechanisms known to those of skill in the art, or the like.

In some embodiments, the distal end of the auger rack 100 is secured by a cup, ring or receptacle affixed to the frame. In various embodiments, the auger rack 200 comprises tip restraints for securing the augers 120. The tip restraints may be adjustable in height accommodating tips of differing heights and sizes. In other embodiments, the augers 120 may be lashed, strapped, fastened, tied, or otherwise connected along the shaft or flightings to the auger rack 200.

In various embodiments of the present invention, the L-shaped cantilevers 108 are not evenly spaced apart so as to accommodate augers 120 of more than one uniform width. The augers 120 are suspended side-by-side in the auger rack 200.

Some embodiments of the present invention comprise one or more crossbeam(s) 116 running between stiffeners 102a and 102b, or between top beams 114. These crossbeams 116 may define one, or a plurality of apertures, for receiving additional member and/or cup-like receptacles with open-tops for securing the tip of an auger 120 suspended from the L-shaped cantilevers 108. These receptacles may be made of steel, wood, and/or polymers, and may comprise baskets, cups, cylinders, cubes, or any other three-dimensional shape with an open top or open upper surface. In some embodiments, the receptacles may comprise clasps or rings which grip the auger 120 laterally from the side.

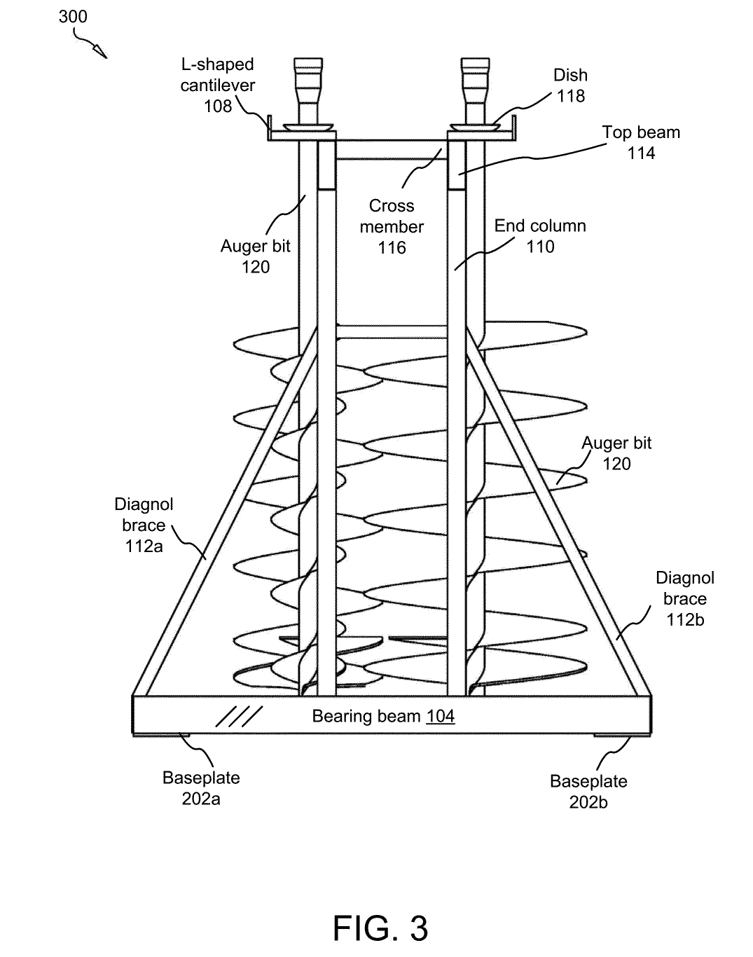

FIG. 3 is a forward perspective view of an auger rack 300 in accordance with the present invention. The auger rack 300 comprises a bearing beam 104, diagonal braces 112a-b, an end column 110, a top beam 114, a cross member 116, an L-shaped cantilever 108, baseplates 202a-b, and an auger bit 120 comprises a dish 118.

The baseplates 202a-d comprise metal, fabric, or polymer spacers affixed to the bottom of the frame, and meant for engaging the ground. In some embodiments, the baseplates 202a-d and/or feet are designed to absorb some level of shock when the auger rack 300 is placed on the ground by mobile equipment. In other embodiments, the baseplates 202a-d are meant to prevent damage from the ground to frame. The baseplates 202a-d may be substantially square, circular, triangular, polygonal, or the like. The baseplates 202a-d may comprise tread, or texturing, to prevent slippage of the auger rack 300 across inclined or slippery ground surfaces.

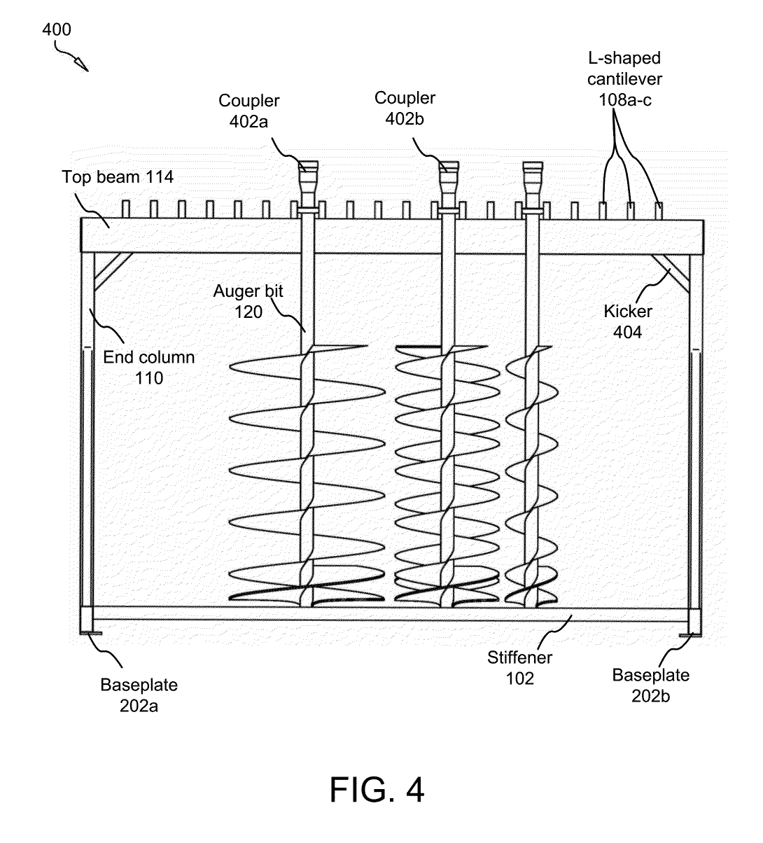

FIG. 4 is a side perspective view of an auger rack 400 in accordance with the present invention.

The auger rack 400 may be lifted by forks attached to a fork lift, crane, skid steer, compact track loader, mini excavator, and the like. In various other embodiments, the rack auger rack 400 comprises fork pockets for a fork lift or lifting points for lifting the rack 400 from a ground surface. Fork pockets may be disposed beneath the body of the device, or incorporated into rack 400 components traversing the x axis and/or y axis of the upper beam.

In various embodiments of the present invention, the L-shaped cantilevers 108 may be substituted for another cantilevered-type bracket used for suspending an auger 120 by its shaft. These brackets may comprise any fork-shaped protrusion from the top beam 114. In some embodiments, the brackets are formed as one integrated piece with the top beam(s) 114.

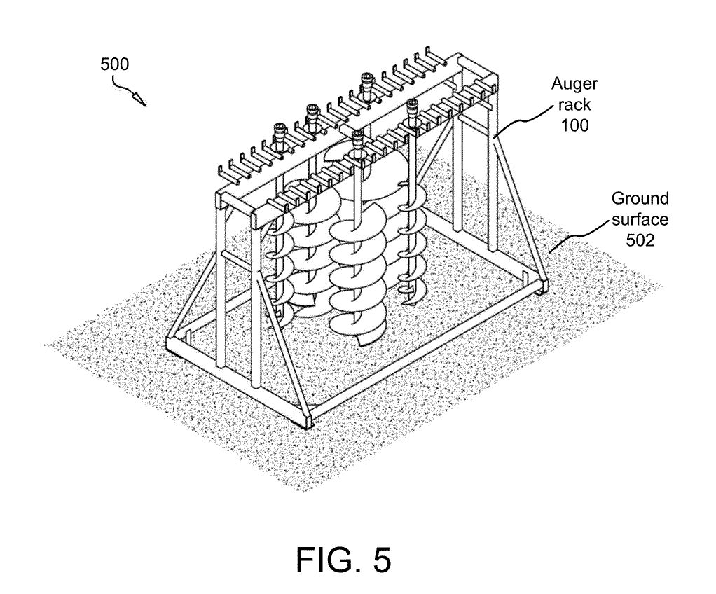

FIG. 5 is a side elevational perspective view of an auger rack 500 in accordance with the present invention.

The auger rack 500 may placed on a ground surface 502 or affixed to the ground surface 502 using means known to those of skill in the art.

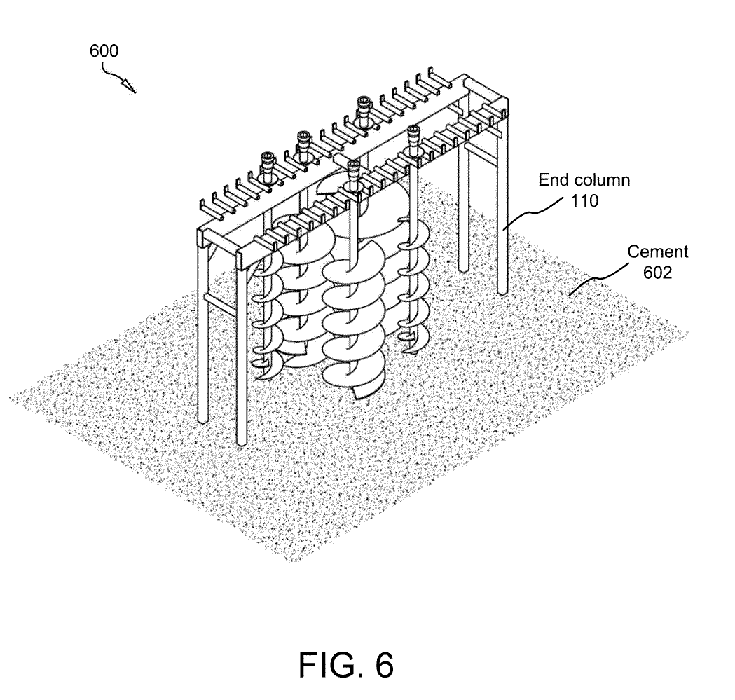

FIG. 6 is a side elevational perspective view of an auger rack 600 cemented in the ground in accordance with the present invention.

In various embodiments of the present invention, the auger rack 600 is cemented into a ground surface. In those embodiments, the frame may only consist of the components from the end columns 110 upward.

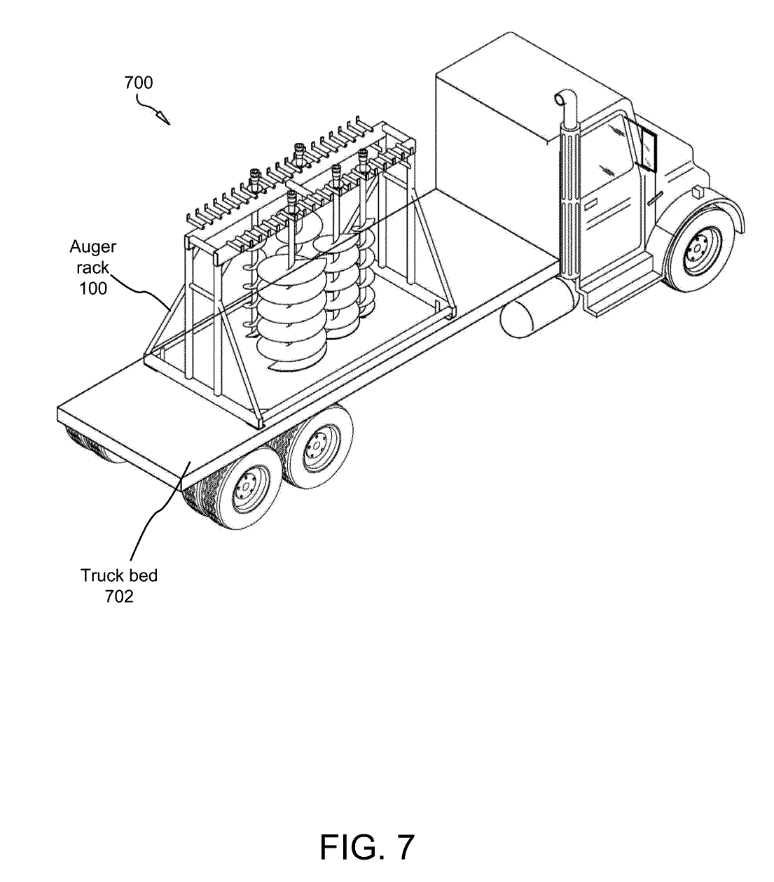

FIG. 7 is a side perspective view of an auger rack 700 in a truck bed in accordance with the present invention.

As shown, the auger rack 100 may be transported on the bed 702 a truck. In some embodiments, the auger rack 100 is affixed to the bed 702, detachably or permanently. All components of the rack 700 may be affixed to one another permanently (with welding and the like) or detachably (with bolts, brackets, and the like).

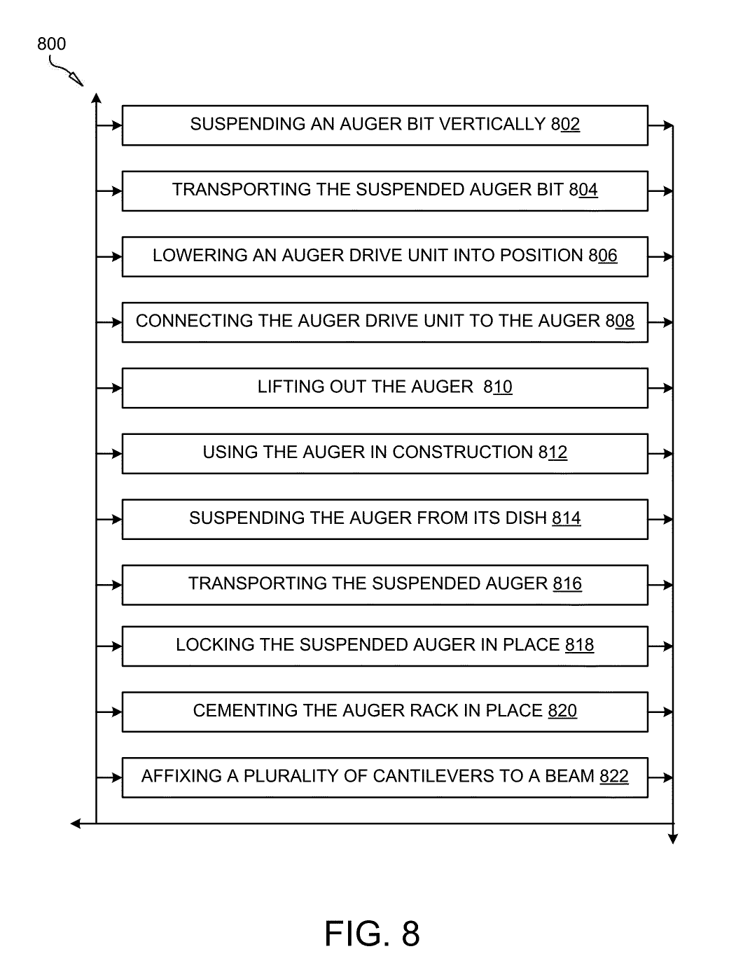

FIG. 8 is a flow chart of the steps of a method for transporting and/or interchanging augers in accordance with the present invention.

The method begins 802 by suspending an auger bit 120 vertically from its dish 118 such that the coupler 402 of the auger bit 120 is upwardly facing at the auger's 120 highest point. The auger 120 is suspended 802 between two cantilevers 108, the cantilevers 108 affixed to a top beam 114.

The method 800 proceeds with the auger 120 being transported 804 to a job site. Some of the steps in the method 800 are optional, steps 804, 816, 818, 820, and 822. Any of the steps may be necessary or optional from one embodiment to another.

An auger drive unit is positioned 806 above the auger 120, and connected 808 to the auger 120. The auger 120 is lifted 810 out of the auger rack 100.

The auger 120 is used 812 for typical purposes in construction, and finally resuspended 814 from the auger rack 100.

In various embodiments, the auger rack 100 may be connected, cemented 820 or otherwise affixed to the bed 702 of a truck or trailer using means known to those of skill in the art. In various embodiments of the present invention, the racks 100-700 may be incorporated into the design a truck, truck bed, or trailer. In still further embodiments, a frame of a truck, trailer, or vehicle may be used as a means of eliminating swaying of the augers 120. The augers 120 may hang through the floor of a truck or trailer bed, the truck or trailer bed defining holes or apertures for receiving the tips, or distal ends, of the augers 120.

The auger rack 100 is created by affixing 822 cantilevers to a top beam 114.

The steps of the provided method 800 makes the augers 120 easy, effortless and safe to connect and disconnect on job sites.

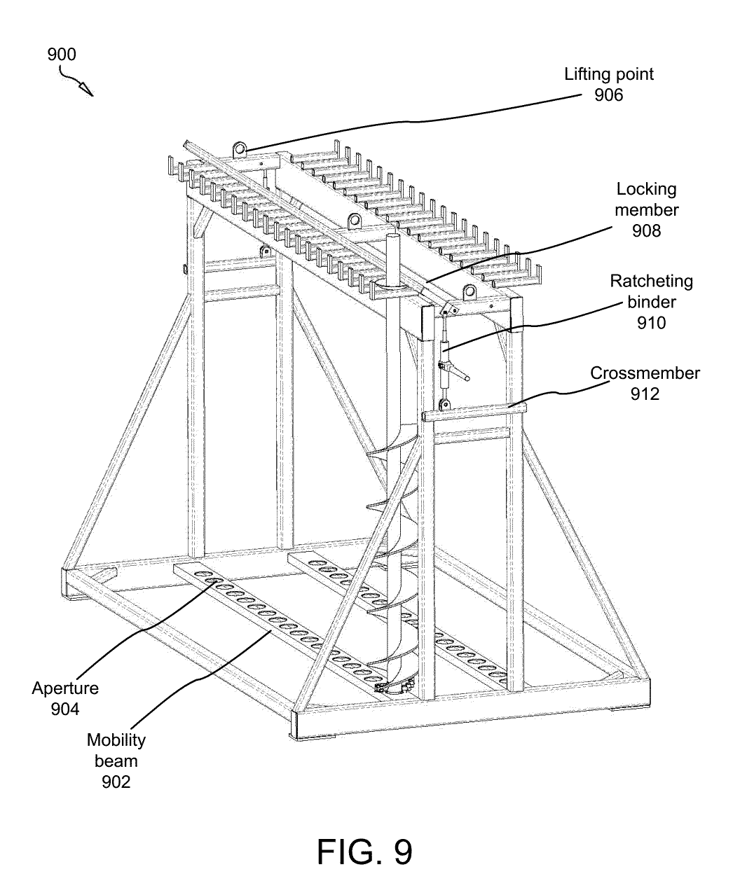

FIG. 9 is a side perspective view of an auger rack 900 in accordance with the present invention. The auger rack 900 comprises a mobility beam 902 having a plurality of apertures 904, a crossmember 912, a ratcheting binder 910, a locking member 908, and a lifting point 906.

The mobility beam 902 comprises a structural component affixed to a lower component of the rack 900 meant for stabilizing the tips of inverted augers 120 during transport. In the shown embodiment, the mobility beam 902 comprises a plurality of apertures 904 into which the tip of the augers 120 are inserted for securement. The mobility beam 902 may be fabricated of metal, alloys, wood, mesh, cable, chain, rope or other means known to those of skill in the art.

In the shown embodiment, the mobility beam 902 is affixed between the bearing beam 104a and the beaming beam 104b, running parallel to the stiffener 102, but may be otherwise disposed or oriented.

The apertures 904 may be circular, square or otherwise shaped, and the aperture 904 may comprise an elongated channel. The apertures 904 may vary in size and diameter.

The shown embodiment includes a crossmember 912. Other embodiments exclude the crossmember 912 or make use of an existing member.

A locking member 908 is hingedly affixed to the cross member 116. The locking member 908 may comprise a U-shaped elongated metal rod, shaft, tube, pipe or like which locks down over a dish 118 of the auger 120.

The locking member 908 is held in place by one or more ratcheting binders 910, which are known to those of skill in the art.

The ratcheting binder 910 can be replaced with a chain, a coupler, a turn buckle, a threaded rod, a tensioning rod, a push-pull rod, a clamp, a rope, pins, fasteners, a cable or via any other means known to those of skill in the art.

The lifting points 906 may be lifting eyes, hooks, bolts, aperture or any other device, rigging, or recess commonly used to facilitate lifting, and may affixed anywhere to the rack 900.

The rack 900 may comprise a platform, catwalk, footpath, access platform, or the like for facilitating operator movement across the top of the rack 900.

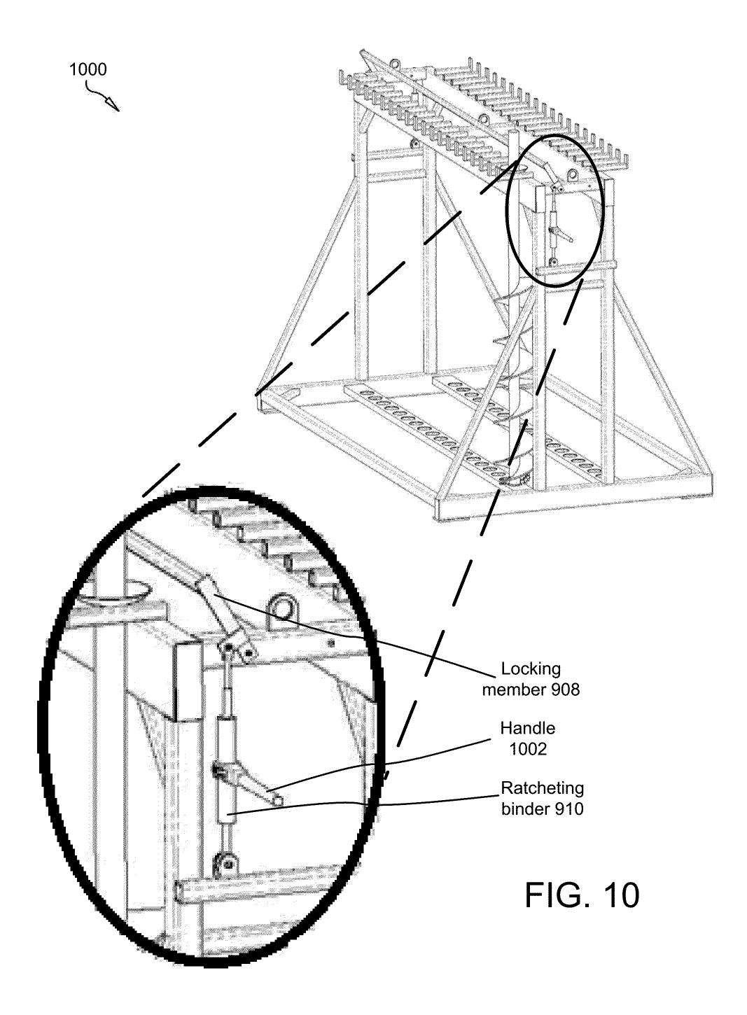

FIG. 10 is a side perspective view of an auger rack 1000, showing an exploded view of a ratcheting binder 910, in accordance with the present invention.

The ratcheting binder 910 comprises a handle 1002 for ratcheting the ratcheting binder 910. The ratcheting binder 910 is hingedly affixed to the locking member 908 as shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An auger rack for suspending augers, the auger rack comprising:
a generally rectangular frame comprising:
one or more bearing beams between 0.1 meters and 20 meters in length, the beaming beams comprising elongated structural components formed from a rigid metallic substance, each bearing beam affixed to one or more upwardly rising end columns;
two or more upwardly rising end columns, between 0.2 meters and 7 meters in length, the end columns comprising elongated structural components formed from a rigid metallic substance, each end column affixed to a bearing beam and to a top beam;
or more top beams between 0.2 meters and 10 meters in length, the top beams comprising elongated structural components formed from a rigid metallic substance, each top beam affixed to one or more end columns;
a plurality of L-shaped cantilevers affixed to a top beam for suspending auger bits, the L-shaped cantilevers affixed in parallel to one another, wherein auger bits are suspended between the L-shaped cantilevers at a dish axially circumventing a shaft of the auger bit.

2. The auger rack of claim 1, further comprising a plurality of outriggers extending laterally from the base of the end columns across a ground surface.

3. The auger rack of claim 1, wherein the L-shaped cantilevers are evenly spaced apart across the top beam.

4. The auger rack of claim 1, further comprising a plurality of feet for engaging a ground surface.

5. The auger rack of claim 1, further comprising one or more diagonal braces affixed to a bearing member at one end and one or more of a top beam and an end column at an opposing end.

6. The auger rack of claim 1, further comprising one or more stiffeners affixed to two bearing members at opposing ends.

7. The auger rack of claim 1, wherein one of a vehicle bed and trailer is affixed to the auger rack.

8. A method of transporting, connecting, and disconnecting an auger to an auger drive unit, the steps of the method comprising:
suspending an auger bit vertically from its dish with its coupler disposed on the auger's upward end, the auger bit suspended between two cantilevers, the cantilevers affixed to a top beam, wherein a diameters of the dish exceeds a width between the cantilevers;
transporting the suspended auger to a construction situs;
lowering an auger drive until into position above the suspended auger;
connecting the auger drive until to the coupler of the auger;
lifting the auger out, and away from, the cantilevers;
using the auger in construction;
suspending the auger bit vertically from its dish with by its coupler between two cantilevers;
disconnecting a drive unit from an auger; and
transporting the suspended auger to another situs.

9. The method of claim 8, the steps of the method further comprising storing the suspended auger between cantilevers.

10. The method of claim 8, the steps of the method further comprising locking the suspended auger in place between cantilevers using a locking mechanism.

11. The method of claim 8, the steps of the method further comprising cementing end columns affixed to the top beam in place on a ground surface.

12. The method of claim 8, further comprising transporting augers in a ready to use position in a rack integrated into the design of one of a trailer and vehicle bed, the augers suspending from one of brackets and L-shaped cantilevers.

13. The method of claim 12, securing the augers on the rack to prevent swaying.

14. An auger rack for suspending augers, the auger rack comprising:
a generally rectangular frame comprising:
one or more bearing beams between 0.1 meters and 20 meters in length, the beaming beams comprising elongated components formed from a rigid metallic substance, each bearing beam affixed to one or more upwardly rising end columns;
two or more upwardly rising end columns, between 0.2 meters and 7 meters in length, the end columns comprising elongated components formed from a rigid metallic substance, each end column affixed to a bearing beam and to a top beam;
or more top beams between 0.2 meters and 10 meters in length, the top beams comprising elongated structural components formed from a rigid metallic substance, each top beam affixed to one or more end columns;
a plurality of brackets affixed in parallel to a top beam for suspending auger bits, wherein auger bits are suspended between the brackets.

15. The auger rack of claim 14, wherein one or more of the end columns and the bearing beams comprise one of I-beams, tubes, bar stock, pipes, channel beam, and angle iron; wherein end columns and bearing beams are detachably connected to the rack such that they can be disassembled and reassembled to facilitate transport.

16. The auger rack of claim 14, wherein the brackets are evenly spaced apart from one another.

17. The auger rack of claim 14, further comprising one or more lifting eyes for craning the auger rack overhead.

18. The auger rack of claim 14, further comprising one or more mobility beams for securing tips of augers during transport.

19. The auger rack of claim 19, wherein the mobility beam defines a plurality of apertures.

20. The auger rack of claim 14, further comprising a locking member hingedly affixed to the auger rack for locking dishes of augers in place, the locking member affixed to one or more ratcheting binders.
